(19) United States
(12) Patent Application Publication
(10) Pub. No.: US 2013/0212881 A1
(43) Pub. Date: Aug. 22, 2013

(54) METHOD OF MANUFACTURING EVAPORATOR WITH COOL STORAGE FUNCTION

(71) Applicant: KEIHIN THERMAL TECHNOLOGY CORPORATION, Oyama-shi (US)

(72) Inventors: Osamu KAMOSHIDA, Oyama-shi (JP); Naohisa HIGASHIYAMA, Oyama-shi (JP)

(73) Assignee: KEIHIN THERMAL TECHNOLOGY CORPORATION, Oyama-shi (JP)

(21) Appl. No.: 13/770,957

(22) Filed: Feb. 19, 2013

(30) Foreign Application Priority Data
Feb. 20, 2012 (JP) 2012-033878

(51) Int. Cl. B23P 15/26

(52) U.S. Cl. CPC B23P 15/26
USPC 29/890.07

(57) ABSTRACT

In a method of manufacturing an evaporator with a cool storage function, a plurality of flat refrigerant flow tubes and a plurality of container forming assemblies are disposed such that a width direction of each of the plurality of flat refrigerant flow tubes and a width direction of each of the plurality of container forming assemblies coincide with a vertical direction. Peripheral edge portions of container forming plates are brazed together to prepare each of the cool storage material containers. The flat refrigerant flow tubes and the cool storage material containers are brazed together.

### CROSS-REFERENCE TO RELATED APPLICATIONS

The present application claims priority under 35 U.S.C. §119 to Japanese Patent Application No. 2012-033878, filed Feb. 20, 2012. The contents of this application are incorporated herein by reference in their entirety.

### BACKGROUND OF THE INVENTION

1. Field of the Invention

The present invention relates to a method of manufacturing an evaporator with a cool storage function.

2. Discussion of the Background

In recent years, in order to protect the environment and improve fuel consumption of automobiles, there has been proposed an automobile designed to automatically stop the engine when the automobile stops, for example, so as to wait for a traffic light to change.

Incidentally, an ordinary car air conditioner has a problem in that, when an engine of an automobile in which the air conditioner is mounted is stopped, a compressor driven by the engine is stopped, and supply of refrigerant to an evaporator stops, whereby the cooling capacity of the air conditioner sharply drops.

As one measure to solve such a problem, imparting a cool storage function to the evaporator has been considered, to thereby enable cooling of a vehicle compartment by releasing the cool stored in the evaporator, when the compressor stops as a result of stoppage of the engine.

The present applicant has proposed such an evaporator with a cool storage function (see Japanese Patent Application Laid-Open (kokai) No 2010-149814). The proposed evaporator includes a pair of header tanks, a plurality of flat refrigerant flow tubes, and a plurality of cool storage material containers. The header tanks are disposed such that they are spaced apart from each other in the vertical direction and they extend in the same direction. The refrigerant flow tubes are disposed in parallel between the two header tanks such that they are spaced apart from one another in the longitudinal direction of the header tanks, their longitudinal direction coincides with the vertical direction, and their width direction coincides with an air-passing direction. An air passage clearance is formed between refrigerant flow tubes adjacent to each other in the longitudinal direction of the header tanks. The cool storage material containers are disposed in some of all the air passage clearances such that their longitudinal direction coincides with the vertical direction and their width direction coincides with the air-passing direction. The cool storage material containers are filled with a cool storage material. At least one of opposite side walls of each cool storage material container is laid along and brazed to the corresponding refrigerant flow tube.

### SUMMARY OF THE INVENTION

According to one aspect of the present invention, an evaporator with a cool storage function includes a plurality of flat refrigerant flow tubes and a plurality of cool storage material containers. The flat refrigerant flow tubes are disposed in parallel to each other at predetermined intervals such that a longitudinal direction of each of the flat refrigerant flow tubes coincides with a vertical direction and a width direction of each of the flat refrigerant flow tubes coincides with an air-passing direction. The plurality of cool storage material containers are disposed such that a longitudinal direction of each of cool storage material containers coincides with the vertical direction and a width direction of each of cool storage material containers coincides with the air-passing direction. The cool storage material containers are provided to be filled with a cool storage material. Each of the cool storage material containers is formed by brazing two container forming plates together. At least one of the two container forming plates has an outward bulging portion provided in a region excluding a peripheral edge portion of the at least one of the two container forming plates. At least one side wall of opposite side walls of each of the cool storage material containers is laid along and brazed to a corresponding refrigerant flow tube. In a method of manufacturing the evaporator with the cool storage function, the plurality of flat refrigerant flow tubes are prepared. Press work is performed on two metallic material plates to provide an outward bulging portion on at least one metallic material plate in a region excluding a peripheral edge portion thereof, and to provide brazability improving grooves to promote flows of molten flux and molten brazing material on portions of the two metallic material plates for preparing two container forming plates. Each of the portions defines an outer surface of each of side walls of the cool storage material container. Each of the two metallic material plates includes a brazing sheet. The brazing sheet has a core material layer and brazing material layers covering opposite sides of the core material layer. The two container forming plates are combined such that an opening of the outward bulging portion of at least one container forming plate faces another container forming plate so as to prepare each of a plurality of container forming assemblies. The plurality of flat refrigerant flow tubes and the plurality of container forming assemblies are disposed such that a width direction of each of the plurality of flat refrigerant flow tubes and a width direction of each of the plurality of container forming assemblies coincide with the vertical direction. Peripheral edge portions of the container forming plates are brazed together to prepare each of the cool storage material containers. The flat refrigerant flow tubes and the cool storage material containers are brazed together.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a partially cut-away perspective view showing the overall structure of an evaporator with a cool storage function manufactured by a method of an embodiment;

FIG. 2 is an enlarged sectional view taken along line A-A of FIG. 1;

FIG. 3 is a side view showing a cool storage material container of the evaporator with a cool storage function of FIG. 1;

FIG. 4 is a perspective view showing one step of a method of manufacturing the evaporator with a cool storage function of FIG. 1;

FIG. 5 is an enlarged partial sectional view showing a method of manufacturing a container forming plate used for the cool storage material containers of the evaporator with a cool storage function of FIG. 1; and

FIG. 6 is a side view showing a modification of the cool storage material container used in the evaporator with a cool storage function of FIG. 1.

### DESCRIPTION OF THE EMBODIMENTS

The embodiments will now be described with reference to the accompanying drawings, wherein like reference numerals designate corresponding or identical elements throughout the various drawings.

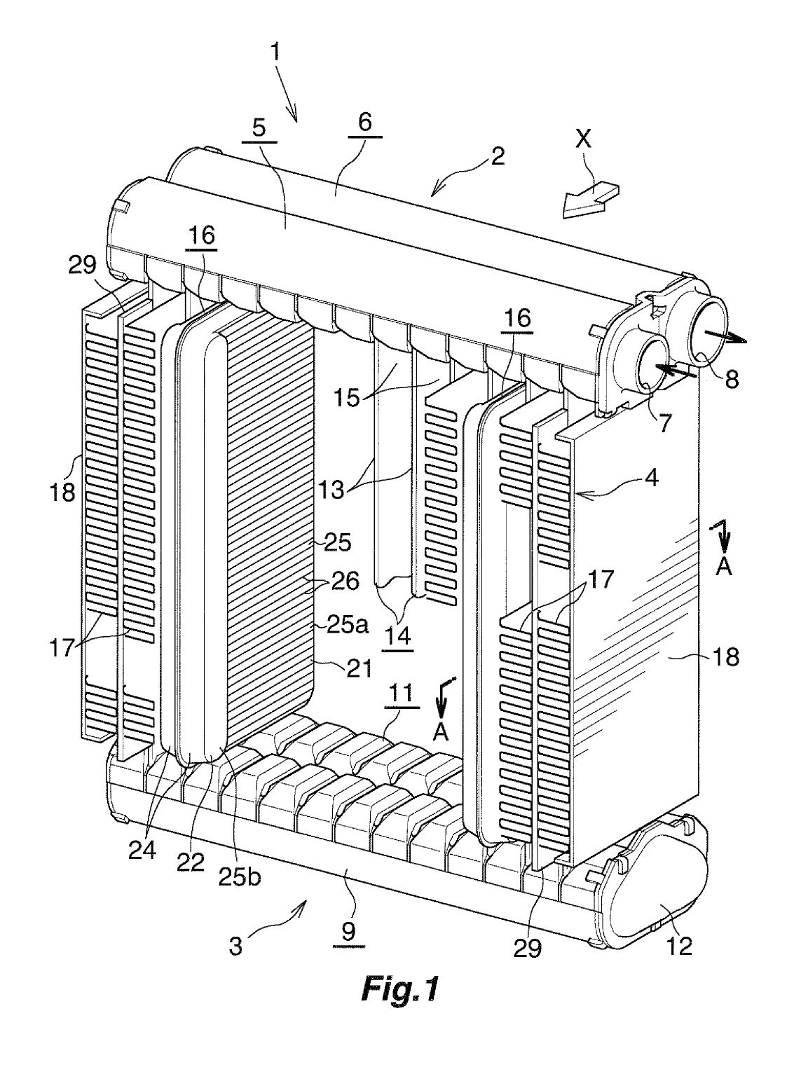

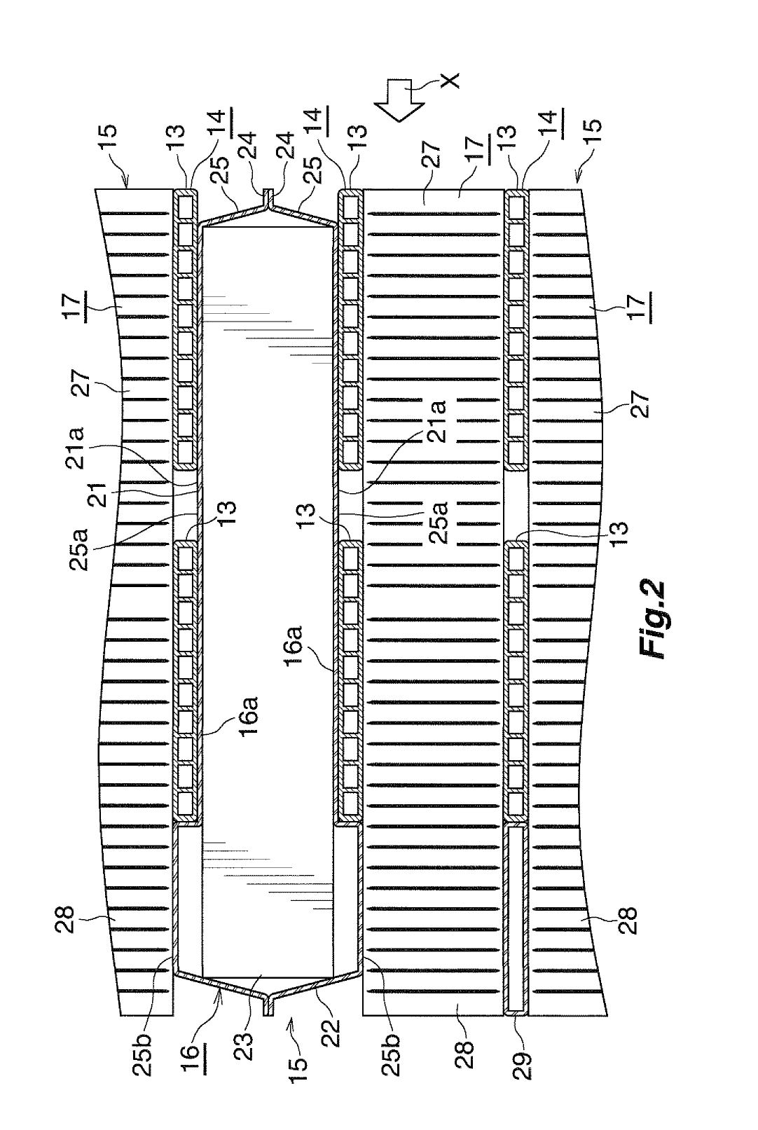

In the following description, the downstream side with respect to an air-passing direction (a direction represented by arrow X in FIGS. 1 and 2) will be referred to as the “front,” and the opposite side as the “rear.” Also, the left-hand and right-hand sides as viewed rearward from the front side; i.e., the left-hand and right-hand sides of FIG. 1 will be referred to as “left” and “right,” respectively. The upper and lower sides of FIG. 1 will be referred to as “upper” and “lower,” respectively.

Furthermore, the term “aluminum” as used in the following description encompasses aluminum alloys in addition to pure aluminum.

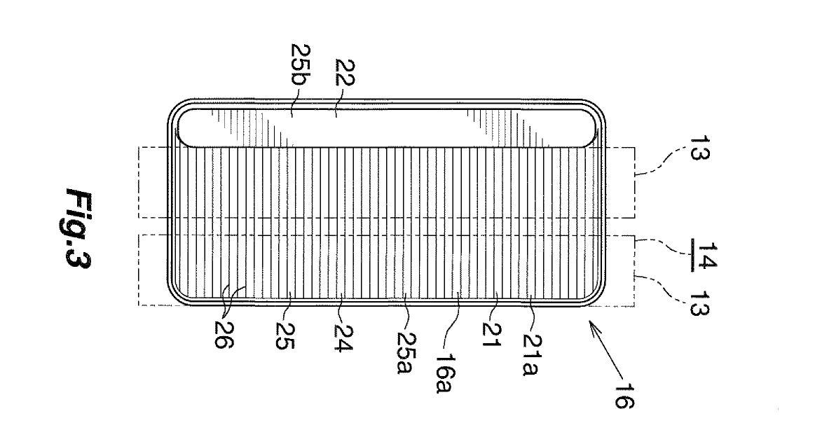

FIG. 1 shows the overall configuration of an evaporator with a cool storage function manufactured by a method of the embodiment, and FIGS. 2 and 3 show the configuration of an essential portion of the evaporator.

As shown in FIG. 1, an evaporator 1 with a cool storage function includes a first header tank 2 and a second header tank 3 formed of aluminum and disposed apart from each other in the vertical direction such that they extend in the left-right direction; and a heat exchange core section 4 provided between the two header tanks 2 and 3.

The first header tank 2 includes a leeward upper header section 5 located on the front side (downstream side with respect to the air-passing direction); and a windward upper header section 6 located on the rear side (upstream side with respect to the air-passing direction) and united with the leeward upper header section 5. A refrigerant inlet 7 is provided at the right end of the leeward upper header section 5, and a refrigerant outlet 8 is provided at the right end of the windward upper header section 6. The second header tank 3 includes a leeward lower header section 9 located on the front side, and a windward lower header section 11 located on the rear side and united with the leeward lower header section 9. The respective interiors of the leeward lower header section 9 and the windward lower header section 11 of the second header tank 3 are connected together via a communication member 12 which is joined to the right end portions of the two lower header sections 9 and 11 and which has an inner space serving as a passage.

As shown in FIGS. 1 and 2, in the heat exchange core section 4, a plurality of flat refrigerant flow tubes 13 which extend in the vertical direction, whose width direction coincides with the air-passing direction (the front-rear direction), and which are formed of aluminum extrudate are disposed in parallel such that they are spaced apart from one another in the left-right direction. In the present embodiment, a plurality of pairs 14 each composed of two refrigerant flow tubes 13 spaced apart from each other in the front-rear direction are disposed at predetermined intervals in the left-right direction. An air-passing clearance 15 is formed between adjacent two of the pairs 14 each composed of the front and rear refrigerant flow tubes 13. An upper end portion of each front refrigerant flow tube 13 is connected to the leeward upper header section 5, and a lower end portion of each front refrigerant flow tube 13 is connected to the leeward lower header section 9. Similarly, an upper end portion of each rear refrigerant flow tube 13 is connected to the windward upper header section 6, and a lower end portion of each rear refrigerant flow tube 13 is connected to the windward lower header section 11.

A flat cool storage material container 16 which is formed of aluminum and which is filled with a cool storage material (not shown) is disposed in each of air-passing clearances 15 selected from all the air-passing clearances 15 of the heat exchange core section 4, the selected passing clearances 15 being not adjacent from one another, such that the cool storage material container 16 extends over the front and rear refrigerant flow tubes 13 in a state in which its longitudinal direction coincides with the vertical direction and its width direction coincides with the front-rear direction. Also, a corrugated outer fin 17 is disposed in each of the remaining air-passing clearances 15 such that the corrugated outer fin 17 extends over the front and rear refrigerant flow tubes 13, and is brazed to the front and rear refrigerant flow tubes 13 of the left-side and right-side pairs 14 which define the air-passing clearance 15. The corrugated outer fin 17 is formed from an aluminum brazing sheet having a brazing material layer on each of opposite surfaces thereof, and has crest portions extending in the front-rear direction, trough portions extending in the front-rear direction, and connection portions connecting the crest portions and the trough portions. The outer fin 17 is disposed in each of the air-passing clearances 15 located on both sides of the air-passing clearance 15 in which the cool storage material container 16 is disposed. Also, the outer fin 17, which is formed from an aluminum brazing sheet having a brazing material layer on each of opposite surfaces thereof, is disposed on the outer side of the pair 14 of the refrigerant flow tubes 13 located at the left end, and is disposed on the outer side of the pair 14 of the refrigerant flow tubes 13 located at the right end. These outer fins 17 are brazed to the corresponding front and rear refrigerant flow tubes 13. Furthermore, a side plate 18 formed of aluminum is disposed on the outer side of each of the outer fins 17 located at the left and right ends, respectively, and is brazed to the corresponding outer fin 17. The spaces between the outer fins 17 and the side plates 18 located at the left and right ends also serve as air-passing clearances.

As shown in FIGS. 2 and 3, each cool storage material container 16 has a main body portion 21 which is located rearward of the front edges of the front refrigerant flow tubes 13 and is brazed to the front and rear refrigerant flow tubes 13 of the corresponding pairs 14; and an outward bulging portion 22 which extends from a front edge portion (a leeward edge portion) of the main body portion 21 and bulges frontward (outward in the air-passing direction) beyond the front edges of the front refrigerant flow tubes 13. The left side surface of the main body portion 21 is laid along one side surface of each of the refrigerant flow tubes 13 located on the left side of the main body portion 21, and the right side surface of the main body portion 21 is laid along one side surface of each of the refrigerant flow tubes 13 located on the right side of the main body portion 21. A corrugated inner fin 23 made of aluminum is disposed in the cool storage material container 16 such that the corrugated inner fin 23 extends from the main body portion 21 to the outward bulging portion 22. The inner fin 23 has crest portions extending in the front-rear direction, trough portions extending in the front-rear direction, and connection portions connecting the crest portions and the trough portions. The trough portions and crest portions of the inner fin 23 are brazed to the left and right side walls 21a of the main body portion 21 of the cool storage material container 16. For example, a paraffin-based latent heat storage material having an adjusted freezing point of about 5 to 10° C. is used as a cool storage material charged into the cool storage material container 16. Specifically, pentadecane, tetradecane, or the like is used.

Each cool storage material container 16 is composed of two generally rectangular container forming plates 24 which are elongated in the vertical direction, which are made of aluminum, and which are brazed together along the peripheral edge portions thereof. Each container forming plate 24 is formed, through press work, from an aluminum brazing sheet having a brazing material layer on each of opposite sides thereof. At least one (both in the present embodiment) of the two container forming plates 24 has an outward bulging portion 25 which bulges outward in the left-right direction in a region excluding the peripheral edge portion thereof, and the peripheral edge portions of the two container forming plates 24, excluding the outward bulging portions 25, are brazed together. The outward bulging portion 25 of each container forming plate 24 is composed of a first portion 25a and a second portion 25b. The first portion 25a is provided on the main body portion 21 of the cool storage material container 16. The second portion 25b is provided on the outward bulging portion 22 of the cool storage material container 16, extends frontward from the first portion 25a, and has a bulging height greater than that of the first portion 25a. The bulging top walls of the two portions 25a and 25b of the outward bulging portions 25 of the two container forming plates 24 form the left and right side walls 16a of the cool storage material container 16. The bulging top walls of the first portions 25a; namely, portions of the outer surfaces of the left and right side walls 21a of the main body portion 21, are brazed to the corresponding refrigerant flow tubes 13. A plurality of grooves 26 are formed on the outer surface of the bulging top wall of the first portion 25a of the outward bulging portion 25 of each of the two container forming plate 24 of the cool storage material container 16. The grooves 26 are formed such that they extend in a front-rear direction which is non-parallel to the longitudinal direction of the refrigerant flow tubes 13 and they are spaced apart from one another in the vertical direction.

Each outer fin 17 has a fin main body portion 27 which is located rearward of the front edges of the front refrigerant flow tubes 13 and is brazed to the front and rear refrigerant flow tubes 13 of the corresponding pairs 14; and an outward bulging portion 28 which extends from the front edge of the fin main body portion 27 and bulges frontward beyond the front edges of the front refrigerant flow tubes 13. The outward bulging portions 28 of the outer fins 17 disposed in the air-passing clearances 15 adjacently located on the opposite sides of the air-passing clearance 15 in which the cool storage material container 16 is disposed are brazed to the left and right side surfaces of the outward bulging portions 22 of the cool storage material container 16. Also, a spacer 29 made of aluminum is disposed between the outward bulging portions 28 of the outer fins 17 adjacent to each other and is brazed to the outward bulging portions 28.

In the above-described embodiment, the cool storage material container 16 is composed of the two container forming plates 24 which have the outward bulging portions 25 formed in respective regions excluding the peripheral edge portions thereof such that the outward bulging portions 25 bulge outward in the left-right direction, and the cool storage material container 16 is manufactured by brazing together the peripheral edge portions of the two container forming plates 24 excluding the outward bulging portions 25. Alternatively, the cool storage material container 16 may be manufactured as follows. The outward bulging portion 25 which bulges outward in the left-right direction is provided on one of the container forming plates 24 in a region excluding the peripheral edge portion thereof. The peripheral edge portions of the two container forming plates 24 are brazed together such that the opening of the outward bulging portion 25 of one container forming plate 24 is closed.

The above-described evaporator 1 with a cool storage function constitutes a refrigeration cycle in combination with a compressor driven by an engine of a vehicle, a condenser (refrigerant cooler) for cooling the refrigerant discharged from the compressor, and an expansion valve (pressure-reducing unit) for reducing the pressure of the refrigerant having passed through the condenser. The refrigeration cycle is installed, as a car air conditioner, in a vehicle, such as an automobile, which temporarily stops the engine, which serves as a drive source of the compressor, when the vehicle is stopped. In the case of such a car air conditioner, when the compressor is operating, low pressure, two-phase refrigerant (a mixture of vapor refrigerant and liquid refrigerant) having been compressed by the compressor and having passed through the condenser and the expansion valve passes through the refrigerant inlet 7, and enters the leeward upper header section 5 of the evaporator 1. The refrigerant then passes through all the front refrigerant flow tubes 13, and flows out from the refrigerant outlet 8 of the windward upper header section 6. When the refrigerant flows through the refrigerant flow tubes 13, the refrigerant performs heat exchange with air passing through the air-passing clearances 15, and flows out in a vapor phase.

At that time, the cool carried by the refrigerant flowing through the refrigerant flow tubes 13 is transferred to the inner fin 23 of each cool storage material container 16 via the first portions 25a of the outward bulging portions 25 of the two container forming plates 24 of the cool storage material container 16, and is further transferred to the cool storage material within the cool storage material container 16, whereby cool is stored in the cool storage material.

When the compressor stops, the cool stored in the cool storage material within each cool storage material container 16 is transferred via the inner fin 23 to the first portions 25a of the outward bulging portions 25 of the two container forming plates 24 of the cool storage material container 16, and then transferred to the refrigerant flow tubes 13. After passing through the refrigerant flow tubes 13, the cool is transferred to the outer fins 17 brazed to the refrigerant flow tubes 13. Also, the cool stored in the cool storage material within each cool storage material container 16 is transferred to the second portions 25b of the outward bulging portions 25 of the two container forming plates 24 of the cool storage material container 16, and then transferred to the outer fins 17 through the second portions 25b. Subsequently, the cool is transferred via the outer fins 17 to air passing through the air-passing clearances 15 adjacently located on the opposite sides of the air-passing clearance 15 in which the cool storage material container 16 is disposed. Accordingly, even when the temperature of air having passed through the evaporator 1 increases, the air is cooled, whereby a sharp drop in cooling capacity can be prevented.

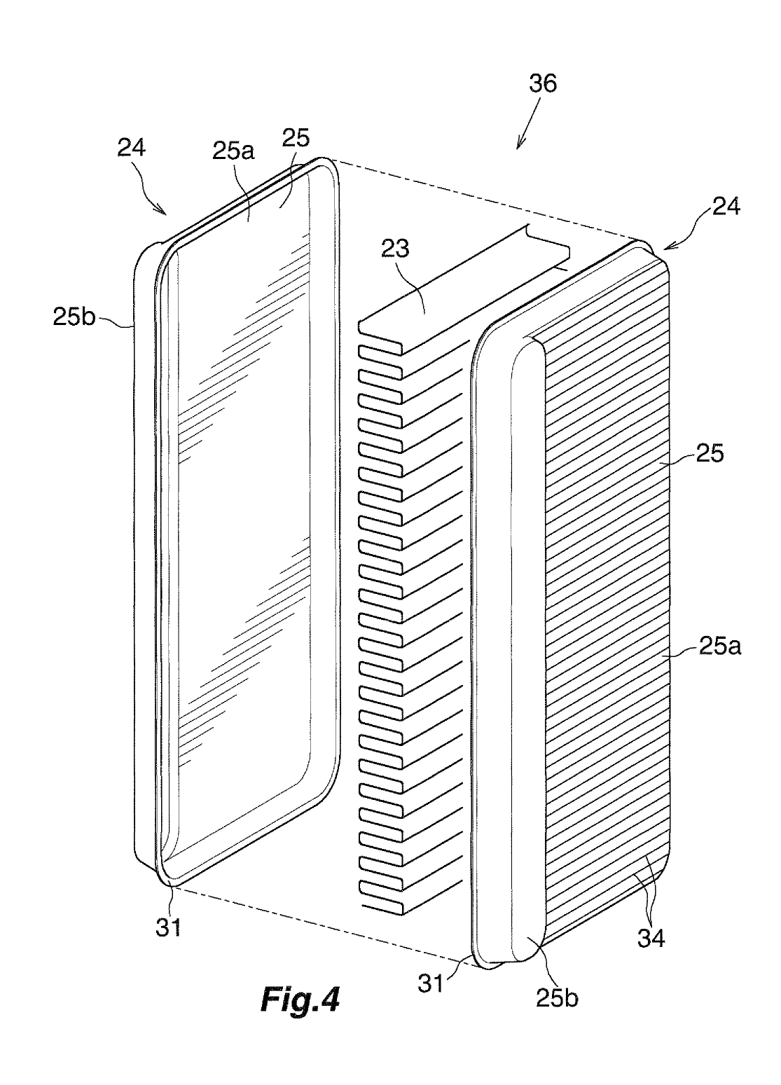

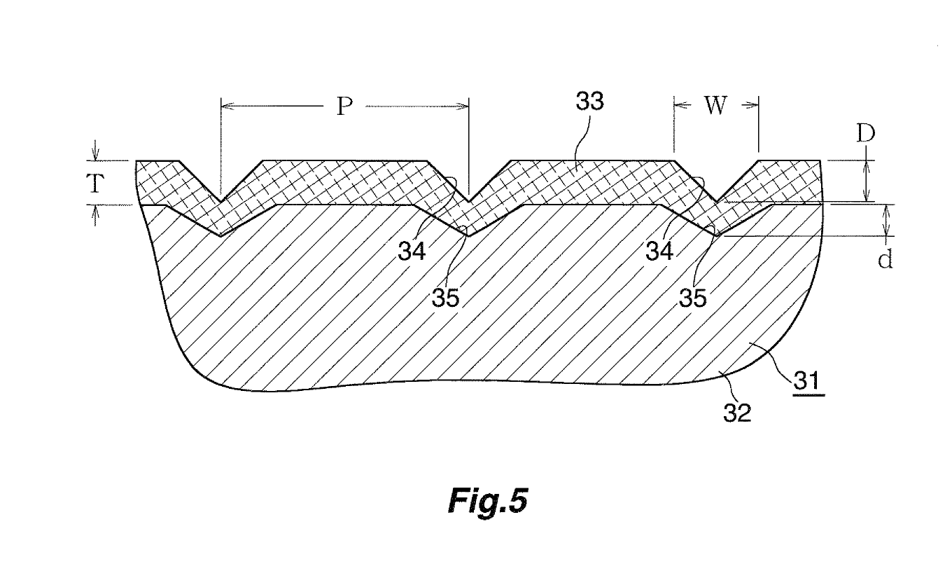

Next, a method of manufacturing the above-described evaporator 1 with a cool storage function will be described with reference to FIGS. 4 and 5.

Components of the two header tanks 2 and 3, the refrigerant flow tubes 13, the outer fins 17, the side plates 18, and the inner fins 23 are prepared.

Also, press work is performed on two metallic material plates 31 each formed from an aluminum brazing sheet which has a core material layer 32 and brazing material layers 33 covering opposite sides of the core material layer 32, whereby the container forming plates 24 are formed. Specifically, the outward bulging portion 25 composed of the first portion 25a and the second portion 25b is formed on each metallic material plate 31 in a region excluding the peripheral edge portion thereof, and brazability improving grooves 34 for promoting the flows of molten flux and molten brazing material are formed on the outer surface of the bulging top wall of the first portion 25a of the outward bulging portion 25 of each metallic material plate 31 such that the brazability improving grooves 34 extend in a direction perpendicular to the longitudinal direction of the refrigerant flow tubes 13. In this manner, the container forming plates 24 are formed

The brazability improving grooves 34 are formed by deforming both of the core material layer 32 and brazing material layers 33 of the metallic material plate 31. The depth D of the brazability improving grooves 34 is smaller than the thickness T of each brazing material layer 33 of the metallic material plate 31. For example, preferably, the depth D of the brazability improving grooves 34 is 50 μm or less. Preferably, the mount of deformation of the core material layer 32 in the depthwise direction of the brazability improving grooves 34; i.e., the depth d of recesses 35 formed on the core material layer 32, is set to 20 μm or less. Preferably, the opening width W of the brazability improving grooves 34 is set to 0.1 to 0.4 mm. Preferably, a groove pitch P, which is the distance between the widthwise centers of the adjacent brazability improving grooves 34, is set to 5 mm or less. Notably, the brazability improving grooves 34 may be grooves of one type selected from V grooves, U grooves, and rectangular grooves. In the present embodiment, the brazability improving grooves 34 are V grooves.

Subsequently, the two container forming plates 24 are combined together, with the inner fin 23 interposed therebetween, such that the openings of the outward bulging portions 25 face each other, whereby a container forming assembly 36 is prepared.

Subsequently, the container forming assemblies 36, the components of the two header tanks 2 and 3, the refrigerant flow tubes 13, the outer fins 17, and the side plates 18 are combined together and are provisionally fixed together. After applying flux to the resultant assembly in an attitude such that the width directions of the refrigerant flow tubes 13 and the container forming assemblies 36 coincide with the vertical direction, the peripheral edge portions of the two container forming plates 24 are brazed together and the two container forming plates 24 and the inner fin 23 are brazed together so as to form the cool storage material container 16. Simultaneously, the two container forming plates 24 and the corresponding refrigerant flow tubes 13 are brazed together, and the remaining components are brazed together. In this manner, the evaporator 1 with a cool storage function is manufactured.

At the time of manufacture of the evaporator 1 with a cool storage function, the molten flux first flows through the brazability improving grooves 34 and fills the entire spaces between each cool storage material container 16 and the corresponding refrigerant flow tubes 13, whereby the oxide film on the surface of the brazing material layer 33 and the oxide film on the surface of the core material layer 32 are broken, and it becomes easier for the molten brazing material to fill the entire spaces between each cool storage material container 16 and the corresponding refrigerant flow tubes 13. Accordingly, the completeness of the brazing between each cool storage material container 16 and the corresponding refrigerant flow tubes 13 is enhanced. In particular, since the brazability improving grooves 34 are formed such that they extend in a direction which is non-parallel to the longitudinal direction of the refrigerant flow tubes 13, in the case where the brazing is performed in the above-described attitude, the molten flux and the molten brazing material flow downward due to the force of gravity. Therefore, there hardly remain regions where the molten flux and the molten brazing material do not reach. The recesses 35 formed on the core material layer 32 at positions corresponding to the brazability improving grooves 34 become the grooves 26.

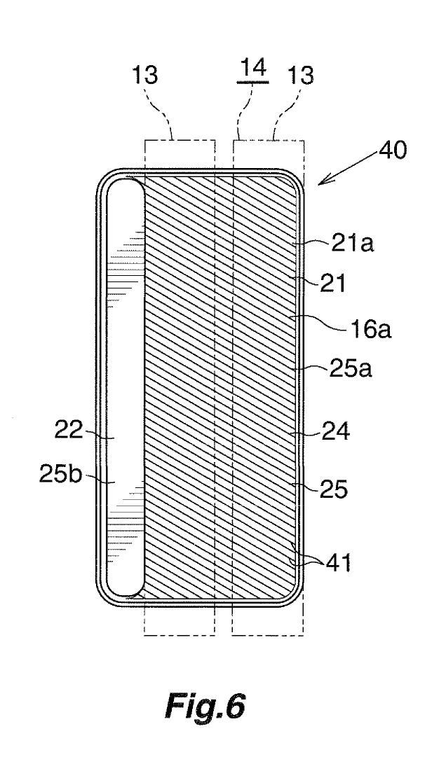

FIG. 6 shows a modification of the cool storage material container used in the evaporator 1 with a cool storage function.

In the case of a cool storage material container 40 shown in FIG. 6, a plurality of grooves 41 which incline downward toward the rear side and are non-parallel to the longitudinal direction of the refrigerant flow tubes 13 are formed on the outer surface of each of the bulging top walls of the first portions 25a of the outward bulging portions 25 of the two container forming plates 24 of each cool storage material container 16 such that the grooves 41 are parallel to one another and spaced apart from one another.

The evaporator 1 including the cool storage material containers 40 shown in FIG. 6 is manufactured in the same manner as the evaporator 1 including the cool storage material containers 16 except that when the container forming plates 24 are formed, the brazability improving grooves 34 which are inclined relative to the longitudinal direction of the refrigerant flow tubes 13 so as to be non-parallel to the longitudinal direction of the refrigerant flow tubes 13 are formed on the outer surface of each of the bulging top walls of the first portions 25a of the outward bulging portions 25 of the two metallic material plates 31.

1) A method of manufacturing an evaporator with a cool storage function including a plurality of flat refrigerant flow tubes which are disposed in parallel to each other at predetermined intervals such that their longitudinal direction coincides with a vertical direction and their width direction coincides with an air-passing direction; a plurality of cool storage material containers disposed such that their longitudinal direction coincides with the vertical direction and their width direction coincides with the air-passing direction, thee cool storage material containers being filled with a cool storage material, wherein each cool storage material container is formed by brazing two container forming plates together, at least one of the two container forming plates has an outward bulging portion provided in a region excluding a peripheral edge portion thereof, and at least one side wall of opposite side walls of each cool storage material container is laid along and brazed to the corresponding refrigerant flow tube, the method including:

preparing the plurality of flat refrigerant flow tubes;

performing press work on two metallic material plates each formed of a brazing sheet having a core material layer and brazing material layers covering opposite sides of the core material layer such that an outward bulging portion is formed on at least one metallic material plate in a region excluding a peripheral edge portion thereof, and brazability improving grooves for promoting flows of molten flux and molten brazing material are formed on portions of the two metallic material plates which portions form the outer surfaces of the side walls of the cool storage material container, whereby the two container forming plates are formed;

combining the two container forming plates such that the opening of the outward bulging portion of at least one container forming plate faces the other container forming plate so as to prepare each of a plurality of container forming assemblies;

disposing the plurality of refrigerant flow tubes and the plurality of container forming assemblies such that their width directions coincide with the vertical direction; and

brazing the peripheral edge portions of the container forming plates together to thereby form each cool storage material container, and brazing the refrigerant flow tubes and the cool storage material containers together.

2) A method of manufacturing an evaporator with a cool storage function according to par. 1), wherein the brazability improving grooves are formed by deforming both of the core material layer and one brazing material layer of the metallic material plate, and the brazability improving grooves have a depth smaller than a thickness of the brazing material layer of the metallic material plate.

3) A method of manufacturing an evaporator with a cool storage function according to par. 2), wherein the amount of deformation of the core material layer in the depthwise direction of the brazability improving grooves is 20 μm or less.

4) A method of manufacturing an evaporator with a cool storage function according to par. 2), wherein the depth of the brazability improving grooves is 50 μm or less, and the amount of deformation of the core material layer in the depthwise direction of the brazability improving grooves is 20 μm or less.

5) A method of manufacturing an evaporator with a cool storage function according to any one of pars. 1) to 4), wherein the brazability improving grooves have an opening width of 0.1 to 0.4 mm.

6) A method of manufacturing an evaporator with a cool storage function according to par. 1) or 2), wherein the brazability improving grooves are grooves of one type selected from V grooves, U grooves, and rectangular grooves.

7) A method of manufacturing an evaporator with a cool storage function according to par. 1) or 2), wherein a groove pitch which is the distance between the widthwise centers of the brazability improving grooves adjacent to each other is 5 mm or less.

8) A method of manufacturing an evaporator with a cool storage function according to par. 1) or 2), wherein the brazability improving grooves are formed such that they extend in a direction which is non-parallel to the longitudinal direction of the refrigerant flow tubes.

The manufacturing method according to any one of pars. 1) to 8), includes the step of performing press work on two metallic material plates each formed of a brazing sheet having a core material layer and brazing material layers covering opposite sides of the core material layer such that an outward bulging portion is formed on at least one metallic material plate in a region excluding a peripheral edge portion thereof, and brazability improving grooves for promoting flows of molten flux and molten brazing material are formed on portions of the two metallic material plates which portions form the outer surfaces of the side walls of the cool storage material container, whereby the two container forming plates are formed. In steps subsequent to the above-mentioned step, the two container forming plates are combined such that the opening of the outward bulging portion of at least one container forming plate faces the other container forming plate so as to prepare each of a plurality of container forming assemblies, the plurality of refrigerant flow tubes and the plurality of container forming assemblies are disposed such that their width directions coincide with the vertical direction, and flux is applied to them. Subsequently, the peripheral edge portions of the container forming plates are brazed together to thereby form each cool storage material container, and the refrigerant flow tubes and the cool storage material containers are brazed together. During such a manufacturing process, molten flux and molten brazing material flow through the brazability improving grooves. Therefore, it becomes easier for the molten flux and the molten brazing material to complete fill the entire spaces between the cool storage material containers and the refrigerant flow tubes. Accordingly, the completeness of brazing between the cool storage material containers and the refrigerant flow tubes is enhanced.

According to the manufacturing method according to any one of pars. 2) to 4), even in the case where the brazing material layers of each container forming plate melt and flow when the container forming plates are brazed together to thereby form each cool storage material container and the refrigerant flow tubes and the cool storage material containers are brazed together, the brazability improving grooves remain on the container forming plates. Therefore, the molten flux and the molten brazing material flow through the remaining portions of the brazability improving grooves and fill the entire spaces between the cool storage material containers and the refrigerant flow tube.

According to the manufacturing method according to par. 5), when the container forming plates are brazed together to thereby form each cool storage material container and the refrigerant flow tubes and the cool storage material containers are brazed together, there can be generated a capillary force sufficient for the molten flux and the molten brazing material to flow. Therefore, the molten flux and the molten brazing material efficiently fill the entire spaces between the cool storage material containers and the refrigerant flow tubes.

According to the manufacturing method according to par. 7), when the container forming plates are brazed together to thereby form each cool storage material container and the refrigerant flow tubes and the cool storage material containers are brazed together, it becomes easier for the molten flux to reach flat surface portions between the grooves.

According to the manufacturing method according to par. 8), when brazing is performed in an attitude in which the plurality of refrigerant flow tubes and the plurality of container forming assemblies are disposed such that their width directions coincide with the vertical direction, the molten flux and the molten brazing material flow downward due to the force of gravity. Therefore, there hardly remain regions where the molten flux and the molten brazing material do not reach.

Obviously, numerous modifications and variations of the present invention are possible in light of the above teachings. It is therefore to be understood that within the scope of the appended claims, the invention may be practiced otherwise than as specifically described herein.

What is claimed is:

1. A method of manufacturing an evaporator with a cool storage function, the evaporator including a plurality of flat refrigerant flow tubes which are disposed in parallel to each other at predetermined intervals such that a longitudinal direction of each of the flat refrigerant flow tubes coincides with a vertical direction and a width direction of each of the flat refrigerant flow tubes coincides with an air-passing direction, and a plurality of cool storage material containers disposed such that a longitudinal direction of each of cool storage material containers coincides with the vertical direction and a width direction of each of cool storage material containers coincides with the air-passing direction, the cool storage material containers being provided to be filled with a cool storage material, each of the cool storage material containers being formed by brazing two container forming plates together, at least one of the two container forming plates having an outward bulging portion provided in a region excluding a peripheral edge portion of the at least one of the two container forming plates, at least one side wall of opposite side walls of each of the cool storage material containers being laid along and brazed to a corresponding refrigerant flow tube, the method comprising:
preparing the plurality of flat refrigerant flow tubes;
performing press work on two metallic material plates to provide an outward bulging portion on at least one metallic material plate in a region excluding a peripheral edge portion thereof, and to provide brazability improving grooves to promote flows of molten flux and molten brazing material on portions of the two metallic material plates for preparing two container forming plates, each of the portions defining an outer surface of each of side walls of the cool storage material container, each of the two metallic material plates including a brazing sheet having
a core material layer, and
brazing material layers covering opposite sides of the core material layer;
combining the two container forming plates such that an opening of the outward bulging portion of at least one container forming plate faces another container forming plate so as to prepare each of a plurality of container forming assemblies;
disposing the plurality of flat refrigerant flow tubes and the plurality of container forming assemblies such that a width direction of each of the plurality of flat refrigerant flow tubes and a width direction of each of the plurality of container forming assemblies coincide with the vertical direction;
brazing peripheral edge portions of the container forming plates together to prepare each of the cool storage material containers; and
brazing the flat refrigerant flow tubes and the cool storage material containers together.

2. A method of manufacturing an evaporator with a cool storage function according to claim 1, wherein the brazability improving grooves are formed by deforming both of the core material layer and one brazing material layer of the metallic material plate, and the brazability improving grooves have a depth smaller than a thickness of the brazing material layer of the metallic material plate.

3. A method of manufacturing an evaporator with a cool storage function according to claim 2, wherein an amount of deformation of the core material layer in a depthwise direction of the brazability improving grooves is 20 μm or less.

4. A method of manufacturing an evaporator with a cool storage function according to claim 2, wherein the depth of the brazability improving grooves is 50 μm or less, and an amount of deformation of the core material layer in a depthwise direction of the brazability improving grooves is 20 μm or less.

5. A method of manufacturing an evaporator with a cool storage function according to claim 1, wherein the brazability improving grooves have an opening having width of 0.1 to 0.4 mm.

6. A method of manufacturing an evaporator with a cool storage function according to claim 1, wherein each of the brazability improving grooves is one of a V-shaped groove, a U-shaped groove, and a rectangular groove.

7. A method of manufacturing an evaporator with a cool storage function according to claim 1, wherein a groove pitch which is a distance between widthwise centers of the brazability improving grooves adjacent to each other is 5 mm or less.

8. A method of manufacturing an evaporator with a cool storage function according to claim 1, wherein the brazability improving grooves are formed to extend in a direction which is non-parallel to the longitudinal direction of each of the flat refrigerant flow tubes.
